(19) United States
(12) Patent Application Publication
(10) Pub. No.: US 2006/0274989 A1
(43) Pub. Date: Dec. 7, 2006

(54) Glass microspheres having enhanced resonant light scattering properties

(76) Inventors: John S. Gergely, Avondale, PA (US); Kostantinos Kourtakis, Media, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/415,511

(22) Filed: May 2, 2006

Related U.S. Application Data
(60) Provisional application No. 60/687,771, filed on Jun. 6, 2005.

(51) Int. Cl. G02B 6/00

(52) U.S. Cl. 385/12

(57) ABSTRACT

Glass microspheres were subjected to a multistep spheroidization process resulting in enhanced resonant light scattering properties, characterized by having at least three sharp, well-defined resonance peaks in their resonant light scattering spectra. The microspheres have utility in bioanalytical systems which rely on detection of changes in resonant light scattering for detection of analytes.

This patent application claims the benefit of U.S. Provisional Patent Application 60/687,771, filed Jun. 6, 2005.

### FIELD OF THE INVENTION

The invention relates to microspheres for use in bioassays. Specifically, glass forming ingredients were subjected to a multi-step spheroidization process, resulting in a population of microspheres having enhanced resonant light scattering properties, characterized by having at least three sharp, well-defined resonance peaks in their resonant light scattering spectra.

### BACKGROUND OF THE INVENTION

The use of resonant light scattering as an analytical method for determining a particle's identity and the presence and optionally, the concentration of one or more target analytes has been described (Prober et al., copending and commonly owned U.S. patent application Ser. No. 10/702,320 and U.S. Patent Application Publication No. 2005/0019842). In that method, a microparticle is irradiated with light of a given wavelength and the resonant light scattering from the microparticle is detected. As the incident wavelength is scanned (i.e., varied over an analytical wavelength range) a scattering pattern or scattering spectrum as a function of wavelength results. Each particle has a distinct resonance light scattering spectrum that can be used to identify the particle. The presence and optionally the concentration of a target analyte can be determined from the shift in the resonance light scattering spectrum that occurs when the analyte binds to a capture probe attached to the surface of the particle. The magnitude of the shift is related to the concentration of the analyte in the solution.

Particles having various glass compositions may be used in the resonant light scattering method. One group of glass compositions includes those comprising a silicon content of at least about 50 atom % (e.g., borosilicate glasses), and certain calcium-containing glass compositions. In the form of microparticles with diameters of 100 micrometers or less, these compositions have, in most cases, less than three resonances in their resonant light scattering spectrum, so they are not as useful for identification purposes as compositions having three or more identifiable resonances. However, the microparticles comprising a silicon content of at least 50 atom % and typically having a refractive index of 1.4 to 1.6, provide more sensitive detection than higher refractive index glass compositions. Other glass compositions, generally having a refractive index of at least 1.6 (e.g., barium titanium silicon oxide glasses), have resonant light scattering spectra that are characterized by repeating groups of at least three peaks resulting from optical resonances for most particle sizes. These glass compositions are particularly useful for particle identification because of the richness of spectral features in their resonant light scattering spectra. Additionally, these glass compositions are useful for the detection of the presence and optionally, the concentration of one or more target analytes.

Kourtakis et al. (copending and commonly owned U.S. Patent Application No. 60/687,699) disclose that the resonant light scattering properties of glass compositions that have a silicon content of at least about 50 atom %, and certain calcium-containing glass compositions are optimized by a process comprising multiple spheroidization of the glass forming ingredients. The optimized resonant light scattering properties of these compositions are characterized by a reduction in the particle to particle variation in contrast in the resonant light scattering spectra, as measured by the pooled standard deviation in the contrast.

A problem encountered with microparticles having glass compositions that are capable of producing resonant light scattering spectra that are characterized by repeating groups of at least three resonance peaks is that a population of commercially available glass particles contains a relatively low fraction of individual particles, typically less than 50%, that generate a high quality resonant light scattering spectrum, which is characterized by repeating groups of at least three sharp, well-defined peaks.

The production of glass microspheres by means of spheroidization of glass forming ingredients is known. In general, the spheroidization process involves heating the glass forming ingredients to a temperature above their melting point for a sufficient period of time such that the surface tension of the glass converts the ingredients into spherical form. For example, Gu et al. (Biomaterials 25:4029-4035 (2004)) describe the spheroidization of angular glass particles using both flame spraying and inductively coupled radio frequency plasma spraying techniques. Searight et al. in U.S. Pat. No. 3,323,888 describe the manufacture of glass beads using a plasma flame jet to subdivide molten glass stock into the desired small particles. Kopatz et al. in U.S. Pat. No. 4,781,753 describe a process for producing fine spherical particles from non-flowing powders. However, these disclosures do not describe the production of a population of bioactive glass microspheres having enhanced resonant light scattering properties using a process comprising multiple spheroidizations of glass forming ingredients and the subsequent attachment of a capture probe.

Therefore, the problem to be solved is to provide a population of bioactive glass microspheres that have enhanced resonant light scattering properties for use in the identification of the particles and the detection of the presence and optionally, the concentration of one or more target analytes using resonant light scattering.

Applicants have addressed the stated problem by discovering that a population of glass microspheres, produced by a process comprising multiple spheroidizations of glass forming ingredients, have a significantly higher percentage of microspheres that give a high quality resonant light scattering spectrum compared to the starting ingredients.

### SUMMARY OF THE INVENTION

The invention provides a population of bioactive glass microspheres having enhanced resonant light scattering properties, characterized by having at least three sharp, well-defined resonance peaks in their resonant light scattering spectra. Accordingly, in one embodiment the invention provides a population of bioactive glass microspheres having enhanced resonant light scattering properties produced by a process comprising the steps of:
a) subjecting a batch of glass forming ingredients to a spheroidization process two or more times wherein the spheroidization process comprises the steps of:
   i) providing a batch of glass forming ingredients;
   ii) heating the glass forming ingredients of (i) with a heat source that provides a temperature of about 2,000° C. to about 12,000° C. wherein the glass forming ingredients are in motion during the heating;
   iii) quenching the heated ingredients of (ii) wherein a population of microspheres having enhanced resonant light scattering properties is formed; and
b) applying at least one capture probe to the surface of the population of microspheres of (a)(iii) wherein the capture probe is bioactive.

Additionally, the invention provides a population of bioactive glass microspheres having enhanced resonant light scattering properties produced by a process comprising the steps of:
a) subjecting a batch of glass beads to a spheroidization process two or more times wherein the spheroidization process comprises the steps of:
   i) providing a batch of glass beads having a composition selected from the group consisting of:
      [Ba₁₋ₓTi_{y}Si_{y′}B_{y″}Ca_{y′″}O_{(1-x+2y+2y′+3/2y″+y′″)}]₁₋ₐ(AO_{z})ₐ, A)
   wherein 0.6>y>0.1; 0.6>y′>0.05; 0.6>y″≧0; 0.4>y′″≧0; x=y+y′+y″+y′″; A is any of, or a combination of Na, Fe, Sr, and Zr; 0.01>a≧0, and 2≧z≧0.5; and
      [Ba₁₋ₓLa_{y}Si_{y′}Ti_{y″}B_{y′″}Ca_{y′″″}O_{(1-x+3/2 y+2y′+2 y″+3/2 y′″+2 y′″″)}]₁₋ₐ(AO_{z})ₐ; B)
   wherein 0.5>y>0.1; 0.6>y′>0.05; 0.6>y″>0.04; 0.4>y′″≧y≧0; 0.3>y″″≧0; x=y+y′+y″+y′″+y″″; where A is any of, or a combination of Cr, Fe, W, Na and Zr; 0.01>a≧0; and 3≧z≧0.5;
   ii) heating the glass beads of (i) in an argon plasma reactor that provides a temperature of about 6,000° C. to about 9,000° C. wherein the glass beads are passed through the reactor at a flow rate of about 0.5 grams per minute to about 10 grams per minute;
   iii) quenching the heated glass beads of (ii) by passing a gas over the heated glass beads wherein a population of microspheres having enhanced resonant light scattering properties is formed; and
b) applying at least one capture probe to the surface of the population of microspheres of (a)(iii) wherein the capture probe is bioactive.

The invention also provides a population of glass microspheres having enhanced resonant light scattering properties wherein said microspheres comprise the following characteristics:
a) a silicon surface enrichment of about 3% or greater as determined by X-Ray Photoelectron Spectroscopy analysis;
b) a composition selected from the group consisting of:
   [Ba₁₋ₓTi_{y}Si_{y′}B_{y″}Ca_{y′″}O_{(1-x+2y+2y′+3/2y″+y′″)}]₁₋ₐ(AO_{z})ₐ, (i)
wherein 0.6>y>0.1; 0.6>y′>0.05; 0.6>y″≧0; 0.4>y′″≧0; x=y+y′+y″+y′″; A is any of, or a combination of Na, Fe, Sr, and Zr; 0.01>a≧0, and 2≧z≧0.5; and
   [Ba₁₋ₓLa_{y}Si_{y′}Ti_{y″}B_{y′″}Ca_{y′″″}O_{(1-x+3/2 y+2y′+2 y″+3/2 y′″+2 y″″)}]₁₋ₐ(AO_{z})ₐ; (ii)
wherein 0.5>y>0.1; 0.6>y′>0.05; 0.6>y″>0.04; 0.4>y′″≧0; 0.3>y″″≧0; x=y+y′+y″+y′″+y″″; where A is any of, or a combination of Cr, Fe, W, Na and Zr; 0.01>a≧0; and 3≧z≧0.5; and
c) a refractive index of about 1.6 to about 2.1.

The invention also provides a method for the detection of analyte binding to a bioactive glass microsphere comprising:
(a) providing a light scanning source which produces light over an analytical wavelength range;
(b) providing at least one bioactive glass microsphere from the population of bioactive glass microspheres, as disclosed herein, having a capture probe, wherein the capture probe has affinity for at least one analyte;
(c) optionally scanning the bioactive glass microsphere of (b) one or more times over the analytical wavelength range to produce at least one first reference resonant light scattering spectrum for the bioactive glass microsphere of (b);
(d) contacting the bioactive glass microsphere of (c) with a sample suspected of containing at least one analyte where, if the analyte is present, binding occurs between the at least one capture probe and the at least one analyte;
(e) scanning the bioactive glass microsphere of (d) one or more times over the analytical wavelength range to produce at least one second binding resonant light scattering spectrum for each bioactive glass microsphere of (d); and
(f) detecting binding of the at least one analyte to the at least one capture probe by comparing the differences between the resonant light scattering spectra selected from the group consisting of: any of the at least one first reference light scattering spectrum and any of the at least one second light scattering spectrum.

### BRIEF DESCRIPTION OF THE FIGURES

The various embodiments of the invention can be more fully understood from the following detailed description and figures, which form a part of this application.

FIG. 1 shows the configuration of a plasma reactor, which may be used to produce the glass microspheres of the invention.

FIG. 2 is a schematic diagram of the imaging detection system used to measure resonant light scattering from microparticles, as described in Example 1.

FIG. 3 is a digital image of scattered light from a group of microparticles, at a single wavelength of incident light. Both the incident and scattered light were polarized; the directions of the polarization were parallel. The numbers 12, 3, 6, and 9 refer to regions of the scattered light image for each particle as explained in Example 1.

FIG. 4 shows a comparison of a high quality resonant light scattering spectrum that is typical of a population of spheroidized glass microspheres of the invention (FIG. 4a) and poor resonant light scattering spectra that are typical of a population of untreated glass microspheres (FIGS. 4b and 4c).

### DETAILED DESCRIPTION OF THE INVENTION

The invention provides a population of bioactive glass microspheres having enhanced resonant light scattering properties, characterized by having at least three sharp, well-defined resonance peaks in their resonant light scattering spectra. The microspheres are produced using a process comprising multiple spheroidizations of glass forming ingredients, followed by attachment of at least one capture probe to the surface of the resulting microspheres.

The bioactive glass microspheres of the invention have application in methods of specific analyte detection and particle identification, which are based on the measurement of resonant light scattering. The methods are capable of parallel analysis with high multiplicity.

The following definitions and abbreviations are to be used for the interpretation of the claims and the specification.

The term “invention” or “present invention” as used herein is a non-limiting term and is not intended to refer to a any single embodiment of the particular invention, but encompasses all possible embodiments as described in the specification and the claims.

The terms “particle”, “microparticle”, “bead”, “microbead”, “microsphere”, and grammatical equivalents refer to small discrete particles, substantially spherical in shape, having a diameter of about 10 micrometers to about 100 micrometers, preferably about 10 micrometers to about 75 micrometers, more preferably about 10 micrometers to about 50 micrometers.

The term “population of microspheres” refers to a sample of microspheres comprising at least about 20, preferably at least about 30, more preferably at least about 40 individual microspheres.

The term “bioactive” when referring to a capture probe refers to a capture probe that is able to participate in biological interactions, such as interactions between members of binding pairs.

The term “bioactive glass microsphere” refers to a glass microsphere having a capture probe that is bioactive applied to its surface.

The terms “capture probe”, “probe”, “binding agent”, “bioactive agent”, “binding ligand”, or grammatical equivalents, refer to any chemical or biological structure or moiety, for example protein, polypeptide, polynucleotide, antibody or antibody fragment, biological cells, microorganisms, cellular organelles, cell membrane fragments, bacteriophage, bacteriophage fragments, whole viruses, viral fragments, organic ligand, organometallic ligand, and the like that may be used to bind either non-specifically to multiple analytes, or preferentially, to a specific analyte or group of analytes in a sample.

The term “binding-pair” includes any of the class of immune-type binding-pairs, such as, antigen/antibody, antigen/antibody fragment, or hapten/anti-hapten systems; and also any of the class of nonimmune-type binding-pairs, such as biotin/avid in, biotin/streptavidin, folic acid/folate binding protein, hormone/hormone receptor, lectin/specific carbohydrate, enzyme/cofactor, enzyme/substrate, enzyme/inhibitor, or vitamin B12/intrinsic factor. They also include complementary nucleic acid fragments (including DNA sequences, RNA sequences, and peptide nucleic acid sequences), as well as Protein A/antibody or Protein G/antibody, and polynucleotide/polynucleotide binding protein. Binding pairs may also include members that form covalent bonds, such as, sulfhydryl reactive groups including maleimides and haloacetyl derivatives; amine reactive groups such as isothiocyanates, succinimidyl esters, carbodiimides, and sulfonyl halides; and carbodiimide reactive groups such as carboxyl and amino groups.

The phrase “population of bioactive glass microspheres having enhanced resonant light scattering properties” refers to a population of bioactive glass microspheres wherein at least about 60%, preferably at least about 70%, more preferably at least about 80% and most preferably at least about 90% of the individual microspheres produce a high quality resonant light scattering spectrum.

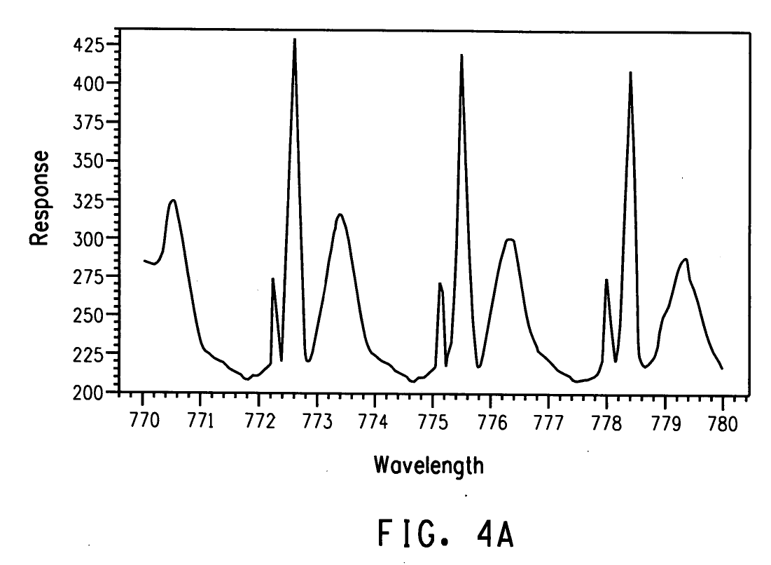

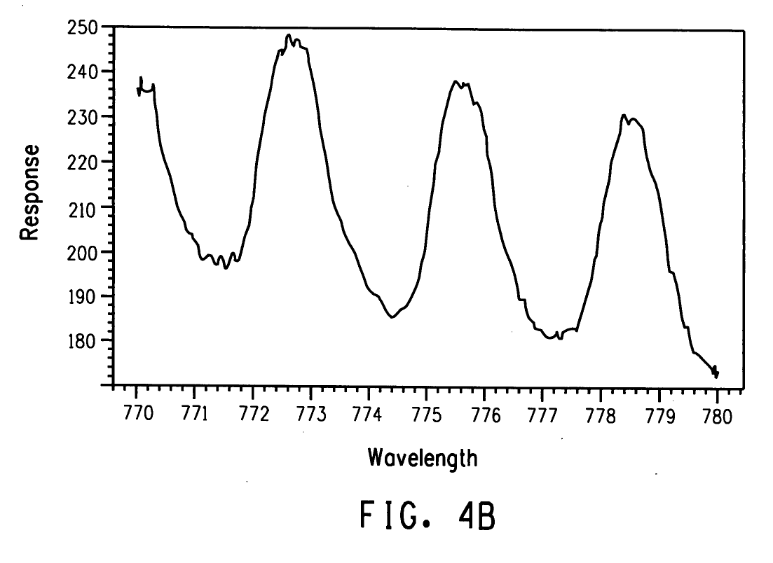

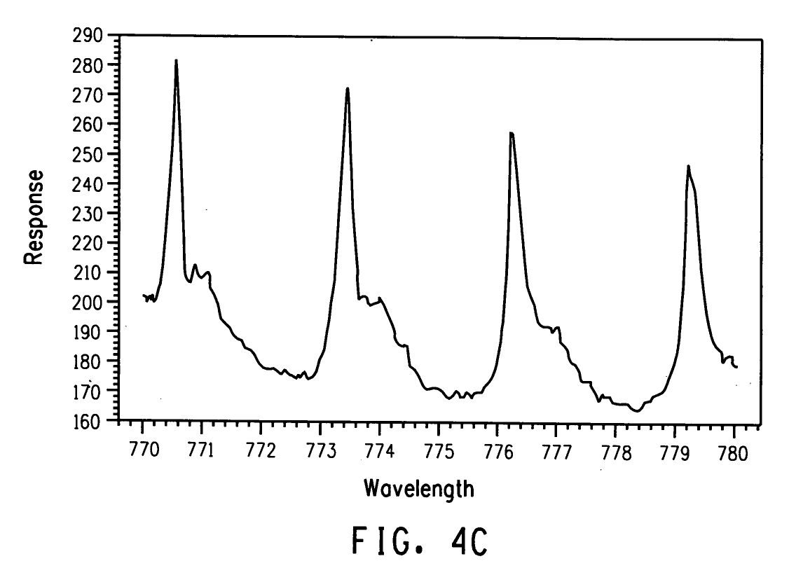

The phrase “high quality resonant light scattering spectrum” refers to a resonant light scattering spectrum characterized by repeating groups of at least three sharp, well-defined peaks resulting from optical resonances, as exemplified by the spectrum shown in FIG. 4a, and as contrasted with the spectra shown in FIGS. 4b and 4c.

The term “spheroidized microspheres” refers to microspheres that result from the multiple spheroidization process of the invention.

The term “resonant light scattering spectrum” refers to a plot of resonant light scattering intensity as a function of wavelength obtained by scanning the glass microspheres of the invention over an analytical wavelength range and measuring the resulting resonant light scattering signal.

The terms “spectral features”, “optical resonance structures”, “identification features”, “scattering resonances”, and “resonant light scattering signatures” are used interchangeably herein to refer to features in the resonant light scattering spectrum that may be used for particle identification, including, but not limited to peak location, peak width, peak order, periods between peaks of different orders, and polarization-dependent spectral properties.

The phrase “richness of spectral features” when used in relation to a resonant light scattering spectrum, refers to a spectrum that has a multitude of spectral features that may be used for particle identification.

The term “silicon surface enrichment” refers to the percent increase in silicon content of the surface of the glass microspheres, relative to the starting ingredients, that results from a multiple spheroidization process. The silicon surface enrichment is expressed as a percent increase in silicon on the surface of the microspheres, calculated as the percent increase in the atom ratio of silicon on the surface in relation to the major elements present in the composition as determined before and after the spheroidization process. The silicon surface enrichment may be determined using surface techniques, such as X-ray photoelectron spectroscopy (also known as ESCA), as described in Example 1.

The terms “protein”, “peptide”, “polypeptide” and “oligopeptide” are herein used interchangeably to refer to two or more covalently linked, naturally occurring or synthetically manufactured amino acids.

The term “analyte” refers to a substance to be detected or assayed using the bioactive glass microspheres of the present invention. Typical analytes may include, but are not limited to proteins, peptides, nucleic acids, peptide nucleic acids, antibodies, receptors, molecules, biological cells, microorganisms, cellular organelles, cell membrane fragments, bacteriophage, bacteriophage fragments, whole viruses, viral fragments, and one member of a binding pair.

The terms “target” and “target analyte” will refer to the analyte targeted by the assay. Sources of targets will typically be isolated from organisms and pathogens such as viruses and bacteria or from an individual or individuals, including but not limited to, for example, skin, plasma, serum, spinal fluid, lymph fluid, synovial fluid, urine, tears, blood cells, organs, tumors, and also to samples of in vitro cell culture constituents (including but not limited to conditioned medium resulting from the growth of cells in cell culture medium, recombinant cells and cell components). Additionally, targets may be from synthetic sources.

The term “analytical wavelength range” refers to a wavelength interval over which the microspheres of the present invention are scanned to produce resonant light scattering spectra. The wavelength interval typically has a span of about 1 to about 20 nanometers over the optical wavelengths from about 275 to about 1900 nanometers, preferably from about 600 to about 1650 nanometers. More preferably, the analytical wavelength range spans a range of 10 nanometers from about 770 to about 780 nanometers. It is contemplated that a number of scans of the particles of the invention may be made during the process of identifying an analyte or detecting analyte binding, however each of these scans will be over an “analytical wavelength range” although that range may differ from scan to scan depending on the specific object of the assay.

The term “light scanning source” refers to a source of light whose wavelength may be varied over the analytical wavelength range. Light scanning sources include sources that produce light that may be varied over the analytical wavelength range, such as scanning diode lasers and tunable dye lasers, and polychromatic sources which produce light having a range of wavelengths, such as light-emitting diodes, lamps and the like, used in conjunction with a wavelength-selecting means.

The term “reference resonant light scattering spectrum” refers to the resonant light scattering spectrum that is produced by scanning the microspheres of the present invention over the analytical wavelength range after the capture probe has been applied to the particles or in the case of detection of analyte dissociation from the capture probe, after the analyte has bound to the capture probe. The reference resonant light scattering spectrum may be used to identify the particles and the probes attached thereto and may serve as a baseline for the detection of analyte binding. A number of reference resonant spectra may be obtained by scanning the particles at different times.

The term “binding resonant light scattering spectrum” refers to the resonant light scattering spectrum that is produced by scanning the microspheres of the present invention over the analytical wavelength range after the microspheres are contacted with the analyte. A series of binding resonant light scattering spectra may be obtained to follow the binding in real time. The determination of binding is done by comparing either any one of the binding resonant light scattering spectra to any one of the reference resonant light scattering spectra or anyone of the plurality of binding resonant light scattering spectra with a previous binding resonant light scattering spectrum in the series.

The term “identifying resonant light scattering spectrum” refers to the resonant light scattering spectrum that is produced by scanning the microspheres of the present invention over the analytical wavelength range before the capture probe is applied to the particles. The identifying resonant light scattering spectrum serves to identify the particles so that a known capture probe may be attached and its identity correlated with the identified microsphere.

The invention relates to a population of bioactive glass microspheres having enhanced resonant light scattering properties. The microspheres are produced by a process comprising subjecting glass forming ingredients to a multiple spheroidization process, followed by attachment of a capture probe to the resulting microspheres. A population of commercially available glass beads typically comprises a percentage of only about 30% to about 50% of individual beads that produce a high quality resonant light scattering spectrum. This low percentage makes it difficult to use the beads in analytical methods based upon resonant light scattering. After the multiple spheroidization process of the invention, the percentage of microspheres that produce a high quality resonant light scattering spectrum increases to at least about 60%, preferably at least about 70%, more preferably at least about 80% and most preferably at least about 90% of the population. The percentage improvement, relative to a non-spheroidized control sample, is at least about 20%, preferably at least about 50%, more preferably at least about 70%, and most preferably at least about 90% in the percentage of microspheres in the population that produce a high quality resonant light scattering spectrum relative to the original population.

Glass Forming Ingredients

The glass forming ingredients used in the invention may be in a form, including but not limited to, glass powders, glass beads, crushed glass particles, glass flakes, and raw glass batch (i.e., the solid ingredients which when melted together form glass). In one embodiment, glass beads are used as the glass forming ingredients.

The glass forming ingredients are comprised of materials including, but not limited to, oxides or oxide precursors of barium, titanium, iron, sodium, calcium, boron, niobium, tantalum, lanthanum, silicon, strontium, chromium, and tungsten. Oxide precursors include, but are not limited to, carbonates, acetates, nitrates, or other precursors that can decompose to create the corresponding oxides at elevated temperatures. Barium titanium silicon oxide glasses have been found to be particularly useful in resonant light scattering methods because of the richness of spectral features in their light scattering spectra.

In one embodiment, the glass forming ingredients have a composition of:
[Ba₁₋ₓTi_{y}Si_{y′}B_{y″}Ca_{y′″}O_{(1-x+2y+2y′+3/2y″+y′″)}]₁₋ₐ(AO_{z})ₐ,
wherein 0.6>y>0.1; 0.6>y′>0.05; 0.6>y″≧0; 0.4>y′″≧0; x=y+y′+y″+y′″; A is any of, or a combination of Na, Fe, Sr, and Zr; 0.01>a≧0, and 2≧z≧0.5.

In another embodiment, the glass forming ingredients have a composition of:
[Ba₁₋ₓTi_{y}Si_{y′}B_{y″}Ca_{y′″}O_{(1-x+2y+2y′+3/2y″+y′″)}]₁₋ₐ(AO_{z})ₐ;
wherein x=y+y′+y″+y′″; y=0.394; y′=0.113; y″=0.134; y′″=0.066; a=0.005; 2≧z≧0.5; and wherein A is a combination of Fe, Sr, Na, and Zr.

In another embodiment, the glass forming ingredients have a composition of:
[Ba₁₋ₓLa_{y}Si_{y′}Ti_{y″}By_{′″}Ca_{y′″″}O_{(1-x+3/2 y+2y′+2 y″+3/2 y′″+2 y′″″)}]₁₋ₐ(AO_{z})ₐ;
wherein 0.5>y>0.1; 0.6>y′>0.05; 0.6>y″>0.04; 0.4>y′″≧0; 0.3>y″″≧0; x=y+y′+y″+y′″+y″″; where A is any of, or a combination of Cr, Fe, W, Na and Zr; 0.01>a≧0; and 3≧z≧0.5.

In another embodiment, the glass forming ingredients have a composition of:
[Ba₁₋ₓLa_{y}Si_{y′}Ti_{y″}B_{y′″}Ca_{y′″″}O_{(1-x+3/2 y+2y′+2 y″+3/2 y′″+2 y″″)]}₁₋ₐ(AO_{z})ₐ;
wherein y=0.171, y′=0.401, y″=0.044, y′″=0.0614, y″″=0.0194, x=y+y′+y″+y′″+y″″; a=0.0044; 3≧z≧0.5; and A is a combination of Cr, Fe, W, Na, and Zr.

Suitable glass forming ingredients may be obtained from commercial suppliers such as MO-SCI Specialty Products, LLC. (a subsidiary of MO-SCI Corporation, Rolla, Mo.).

Spheroidization Process

The glass forming ingredients may be spheroidized using any spheroidization method known in the art (for example see, Gu et al., Biomaterials 25:40294035 (2004), Searight et al. in U.S. Pat. No. 3,323,888, Kopatz et al. in U.S. Pat. No. 4,781,753, Callander et al. in U.S. Pat. No. 3,293,014, and Davidhoff in U.S. Pat. No. 3,597,177, all of which are incorporated herein by reference). In the method of the invention, the batch of glass forming ingredients is subjected to the spheroidization process two or more times. The number of spheroidizations required to obtain the enhanced resonant light scattering properties may be readily determined by one skilled in the art using routine experimentation.

In the spheroidization process, the glass forming ingredients are heated to a temperature above the softening point of the ingredients. The glass forming ingredients are kept in motion during the heating. The temperature required depends on the composition of the glass forming ingredients used. The temperature of the heat source is typically between about 2,000° C. and about 12,000° C., preferably, between about 3,000° C. and about 11,000° C., and more preferably, between about 6,000° C. and about 9,000° C. In one embodiment, the temperature of the heat source is about 9,000° C. Preferably, glass compositions containing a reducible component, such as titanium dioxide, are heated in an oxidizing atmosphere, such as air or oxygen.

The glass forming ingredients may be heated using any heat source that provides a temperature that is above the softening temperature of the ingredients. For example, the glass forming ingredients may be heated using a flame torch, as described by Gu et al. supra. Additionally, the glass forming ingredients may be heated using a radio frequency (RF) plasma torch (available, for example, from Tekna Plasma System, Inc. Canada), or a direct current (DC) plasma torch (available, for example, from Westinghouse Plasma Corp., Madison, Pa.). Examples of the spheroidization of glass forming ingredients using a plasma torch are described by Gu et al. supra, Searight et al., supra, and Kopatz et al., supra. The glass forming ingredients may also be heated using a rotating tube furnace, as described by Mathers et al. in U.S. Pat. No. 5,942,280, or using an electric arc, as described by Wald et al. in U.S. Pat. No. 2,859,560, both of which are incorporated herein by reference. Alternatively, the glass forming ingredients may be heated using a high-energy carbon dioxide laser, as described in GB1294950A, incorporated herein by reference.

The glass forming ingredients are kept in motion during heating so that their surface tension is aided by the movement to effect spheroidization. The motion may be accomplished using any suitable means known in the art. For example, the ingredients may be passed through a flame or plasma torch in a flow through configuration. Additionally, the glass forming ingredients may be kept in motion using a rotary kiln during heating. The time that the glass forming ingredients are heated depends on the nature and composition of the ingredients as well as the heat source used. If the glass forming ingredients are flowed through the heat source, the time of heating is controlled by the flow rate. The time required for any particular system may be determined by routine experimentation by one skilled in the art. Typically, the time of heating is about one millisecond to about 100 milliseconds.

After heating, the heated ingredients are quenched (i.e., cooled rapidly to room temperature) to form the spheroidized microspheres. Quenching may be accomplished using any suitable means, including, but not limited to, passing a gas over the heated ingredients or collecting the heated ingredients in a cooling liquid such as water or a suitable oil. The quench rate used will vary depending on the glass composition. Quench rates of less than 100 milliseconds are preferred.

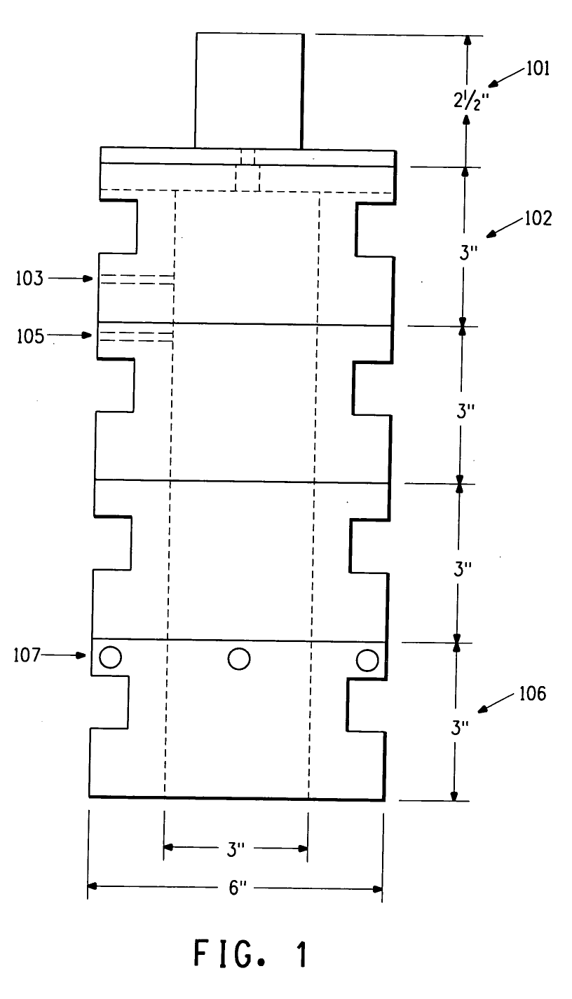

In one embodiment, the glass forming ingredients are spheroidized using a thermal argon plasma reactor, such as that shown in FIG. 1. The reactor has a DC plasma torch (101) (available from Sulzer Metco (US) Inc., Westbury, N.Y.) having a water-cooled copper cathode with a thoriated tungsten tip and a water-cooled copper anode. Argon is used as the plasma gas with typical flow rates being from about 12.5 to about 50 liters per minute. A rotating arc is maintained between the cathode and anode by means of an axial magnetic field from an electromagnet placed around the plasma torch (101) to prevent anchoring of the arc to the anode. The current to generate the plasma may vary between about 70 amperes (for a plasma temperature of approximately 5,000° C.) to about 400 amperes (for a plasma temperature of approximately 13,000° C.).

Below the argon plasma torch is a 3 inch (7.6 cm) spacer (102) having a radial port (103), which is used to feed oxygen into the hot argon from the plasma torch. The flow rate ratio of argon to oxygen is typically about 1.4. The glass forming ingredients are fed into the reactor through the powder feed port (105) by means of oxygen flow from a powder feeder (Sulzer Metco Holding AG, CH-8401 Winterthur, Switzerland) that is modified to feed small amounts of ingredients continuously. The modification consists of a dip tube that is placed in the powder cloud above the argon fluidizing gas. Raising or lowering the dip tube changes the rate of feed. Typically, a feed rate of about 0.5 to about 10 grams of ingredients per minute is used. In one embodiment, the feed rate is about 1 gram per minute.

The heated glass forming ingredients then enter a quench chamber (106) where they diverge and are further cooled by oxygen, which is fed through the three radial ports (107) in the quench chamber at a flow rate of about 30 liters per minute. The spheroidized microspheres then pass through an adapter (not shown) into the product collector (not shown), which consists of a 3 micrometer sintered Inconel® filter (Inconel® refers to a family of trademarked high strength austenitic nickel-chromium-iron alloys) available from GKN Sinter Metals, Chicago, Ill. This entire process is repeated at least once by feeding the collected product back into the reactor to give a population of microspheres having enhanced resonant light scattering properties.

The resulting population of microspheres comprises microspheres that are substantially spherical in shape, and have a diameter of about 10 micrometers to about 100 micrometers, preferably about 10 micrometers to about 75 micrometers, more preferably about 10 micrometers to about 50 micrometers. The term “substantially spherical”, as used herein, means that the shape of the particles does not deviate from a perfect sphere by more than about 10%. The refractive index of the spheroidized microspheres depends on the glass forming ingredients used. For use in resonant light scattering assays, the refractive index of the spheroidized microspheres of the invention is about 1.6 to about 2.1. The glass microspheres of the invention have a richness of spectral features in their resonant light scattering spectra, which makes them particularly useful for particle identification, in addition to analyte detection.

The glass microspheres of the invention are further characterized by a surface enrichment of silicon of about 3% or greater compared to the starting glass forming ingredients. The surface enrichment of silicon may be determined using X-ray photoelectron spectroscopy (also known as ESCA) using methods well known in the art (see Example 1). Briefly, ESCA is used to determine the elemental surface content of the spheroidized microspheres and the initial glass forming ingredients. The ratio of silicon on the surface to the sum of the major elements in the composition is calculated and compared for the two samples.

An additional benefit of the multiple spheroidization process of the invention is that surface imperfections in the starting glass beads are significantly reduced, thereby improving their microfluidic handling properties.

Measurement of Resonant Light Scattering

The resonant light scattering properties of the spheroidized microspheres are measured as described by Prober et al. in copending and commonly owned U.S. Patent Application Publication No. 2005/0019842, which is incorporated herein by reference, and as exemplified in Example 1. The population of spheroidized glass microspheres has enhanced resonant light scattering properties. Specifically, the population of glass microspheres has at least about 60%, preferably at least about 70%, more preferably at least about 80% and most preferably at least about 90% of the individual microspheres that produce a high quality resonant light scattering spectrum. The percentage improvement, relative to a non-spheroidized control sample, is at least about 20%, preferably at least about 50%, more preferably at least about 70%, and most preferably at least about 90% in the percentage of microspheres in the population that produce a high quality resonant light scattering spectrum relative to the original population. A high quality resonant light scattering spectrum that results from the spheroidization process of the invention is characterized by repeating groups of at least three sharp, well defined peaks, as shown in FIG. 4a. For comparison, poor quality resonant light scattering spectra are shown in FIGS. 4b and 4c (see Example 1).

The number of resonance peaks in the resonant light scattering spectrum of a glass particle depends on several factors, including the refractive index of the particle, the size of the particle, and the glass composition. The number of resonances to be expected for a particle having a given refractive index and size may be predicted using Mie theory (see for example, Conwell, P. R. et al., “Efficient automated algorithm for the sizing of dielectric microspheres using the resonance spectrum”, J. Opt. Soc. America A 1, 1181-1186 (1984); Lam, C. C. et al., “Explicit asymptotic formulas for the positions, widths, and strengths of resonances in Mie scattering”, J. Opt. Soc. America B 9, 1585-1592 (1992); Chylek, P., “Resonance structure of Mie scattering: distance between resonances”, J. Opt. Soc. America A 7, 1609-1613 (1990); and Guimaraes, L. G., and Nussenzveig, H. M., “Uniform approximation to Mie resonances”, J. Modern Optics 41, 625-647 (1994)). For example, a particle with a refractive index of 1.6 and a particle diameter of 100 or 75 micrometers, would be predicted to give 3 resonance peaks, while a particle of the same refractive index, but with a particle size of 50 micrometers would be expected to give two resonance peaks. Additionally, a particle with a refractive index of 1.9 and a diameter of about 20 micrometers or less would be expected to give two resonance peaks. The glass microspheres of the invention are capable of producing at least three resonance peaks in their resonant light scattering spectrum.

Bioactive Glass Microspheres

The bioactive glass microspheres of the invention are prepared by applying a capture probe that is bioactive to the surface of the spheroidized microspheres. The capture probe may be any chemical or biological structure or moiety, including, but not limited to, protein, polypeptide, polynucleotide, antibody or antibody fragment, biological cells, microorganisms, cellular organelles, cell membrane fragments, bacteriophage, bacteriophage fragments, whole viruses, viral fragments, organic ligand, organometallic ligand, and the like that may be used to bind either non-specifically to multiple analytes, or preferentially, to a specific analyte or group of analytes in a sample.

The probe may be applied to the surface of the spheroidized microspheres by either directly synthesizing the probe on the surface or by attaching a probe that is naturally occurring or has been synthesized, produced, or isolated separately to the surface using methods known in the art, as described by Prober et al. supra. The utility of the invention is enhanced by using a set of microspheres, each of which has one or more unique capture probes exposed on its surface. Such a set may be generally referred to as a “library” of microspheres or probes.

Bioactive glass microspheres may be prepared by derivatizing the surface of the spheroidized microspheres such that the appropriate capture probes may be attached using linker chemistries or crosslinking chemistries, which are well known in the art. Examples of linking groups include, but are not limited to, hydroxyl groups, amino groups, carboxyl groups, aldehydes, amides, and sulfur-containing groups such as sulfonates and sulfates. Examples of crosslinking chemistries include, but are not limited to, hydroxy reactive groups such as s-triazines and bis-epoxides, sulfhydryl reactive groups such as maleimides and haloacetyl derivatives, amine reactive groups such as isothiocyanates, succinimidyl esters and sulfonyl halides and carboxyl reactive groups such as carbodiimides.

One class of capture probes comprises proteins. By “protein” is meant two or more covalently linked amino acids; thus the terms “peptide”, “polypeptide”, “oligopeptide”, and terms of similar usage in the art are all to be interpreted synonymously in this disclosure. Libraries of protein capture probes may be prepared, for example, from plant or animal cellular extracts, using the linker chemistries described above to attach the protein to the surface of the spheroidized microspheres. Particularly useful and thus preferred are libraries of human proteins, for example human antibodies.

Another class of capture probes comprise nucleic acids or nucleic acid mimics, such as peptide nucleic acids (PNA), which may also be known as “DNA fragments”, “RNA fragments”, “polynucleotides”, “oligonucleotides”, “gene probes”, “DNA probes” and similar terms used in the art, which are all to be considered synonymous in the present disclosure. Methods for preparing nucleic acid probes or pseudo-nucleic acid probes, such as PNA, are well known in the art. For example, the nucleic acid probes may be prepared using standard β-cyanoethyl phosphoramidite coupling chemistry on controlled pore glass supports using commercially available DNA oligonucleotide synthesizers, such as that available from Applied Biosystems (Foster City, Calif.). The synthesized nucleic acid probes may then be coupled to the spheroidized microspheres using covalent or non-covalent coupling, as is well known in the art. Surface preparation of the spheroidized glass microspheres useful for this invention may include, for example, linker chemistry, affinity capture by hybridization or by biotin/avidin affinity, combinatorial chemistry, and others known in the art.

In another approach, the capture probe may be directly synthesized on the surface of the spheroidized microspheres of the invention. Probes that may be directly synthesized on the spheroidized microspheres include, but are not limited to, nucleic acids (DNA or RNA), peptide nucleic acids, polypeptides and molecular hybrids thereof. In the direct synthesis approach, a microsphere that is derivatized with a reactive residue to be used to chemically or biochemically synthesize the probe directly on the microsphere is used. The chemical linkage of the reactive residue must not be cleavable from the microparticle during post-synthesis deprotection and cleanup of the final bioactive glass microspheres (Lohrmann et al., DNA 3, 1222 (1984); Kadonaga, J. T., Methods of Enzymology 208, 10-23 (1991); Larson et al., Nucleic Acid Research 120, 3525 (1992); Andreadis et al. Nucleic Acid Res. 228, e5 (2000); and Chrisey et al. WO/0146471). This approach allows for mass production and assembly of libraries.

In some applications, e.g., assays in complex biological fluids such as urine, cerebrospinal fluid, serum, plasma, and the like, it may be necessary to treat the spheroidized microspheres to prevent or reduce non-specific binding of sample matrix components. Methods to reduce non-specific binding to a variety of solid supports in heterogeneous assays are well known in the art and include, but are not limited to, treatment with proteins such as bovine serum albumin (BSA), casein, and non-fat milk. These treatments are generally done after the attachment of the capture probe to the microspheres, but before the assay to block potential non-specific binding sites. Additionally, surfaces that resist non-specific binding can be formed by coating the surface with a thin film comprising synthetic polymers, naturally occurring polymers, or self-assembled monolayers that consist of a single component or a mixture of components. The thin film may be modified with adsorption-repelling moieties to further reduce non-specific binding. For example, the thin film may be a hydrophilic polymer such as polyethylene glycol, polyethylene oxide, dextran, or polysaccharides, as well as self-assembled monolayers with end functional groups that are hydrophilic, contain hydrogen-bond acceptors but not hydrogen bond donors, and are overall electrically neutral (Ostuni, E. et al., “A Survey of Structure-Property Relationships of Surfaces that Resist the Adsorption of Protein”, Langmuir, 17, 5605-5620, (2001)). In this approach, the non-specific binding resistant layer is generally formed on the substrate and then is chemically activated to allow attachment of the capture probe.

Analyte Detection Using Resonant Light Scattering

Assays carried out with the bioactive microspheres of the present invention may make use of the specific interaction of binding pairs, one member of the pair located on the surface of the bioactive microsphere (also referred to as the “probe”, “binding partner”, “receptor”, or grammatically similar terms) and the other member of the pair located in the sample (referred to as the “target”, “analyte”, or grammatically similar terms). Generally the analyte carries at least one so-called “determinant” or “epitopic” site, which is unique to the analyte and has enhanced binding affinity for a complementary probe site.

The nature of assay types possible with the bioactive microspheres of the invention varies considerably. Probe/target binding pairs may, for example, be selected from any of the following combinations, in which either member of the pair may be the probe and the other the analyte: antigen and specific antibody; antigen and specific antibody fragment; folic acid and folate binding protein; vitamin B12 and intrinsic factor; Protein A and antibody; Protein G and antibody; polynucleotide and complementary polynucleotide; peptide nucleic acid and complementary polynucleotide; hormone and hormone receptor; polynucleotide and polynucleotide binding protein; hapten and anti-hapten; lectin and specific carbohydrate; enzyme and cofactor; enzyme and substrate; enzyme and inhibitor; biotin and avidin or streptavidin; and hybrids thereof, and others as known in the art. Binding pairs may also include members that form covalent bonds, such as, sulfhydryl reactive groups such as maleimides and haloacetyl derivatives, and amine reactive groups such as isothiocyanates, succinimidyl esters, sulfonyl halides, and carbodiimide reactive groups such as carboxyl and amino groups.

Specific examples of binding assays include those for naturally occurring targets, for example, antibodies, antigens, enzymes, immunoglobulin (Fab) fragments, lectins, various proteins found on the surface of cells, haptens, whole cells, cellular fragments, organelles, bacteriophage, phage proteins, viral proteins, viral particles and the like. These may include allergens, pollutants, naturally occurring hormones, growth factors, naturally occurring drugs, synthetic drugs, oligonucleotides, amino acids, oligopeptides, chemical intermediates, and the like. Practical applications for such assays include for example, monitoring health status, detection of drugs of abuse, pregnancy and pre-natal testing, donor matching for transplantation, therapeutic dosage monitoring, detection of disease (e.g. cancer antigens and pathogens), sensors for biodefense, medical and non-medical diagnostic tests, and similar applications known in the art.

Assays using the bioactive glass microspheres of the invention may be done using various specific resonant light scattering protocols and instrumentation as described by Prober et al., supra. For example, analyte binding to a bioactive microsphere may be detected and the amount of analyte in the sample may be determined. In general, when determining binding of an analyte by resonant light scattering methods, at least two measurements are made, one before exposing the particles to the analyte to establish a baseline, and one after exposing the particles to the analyte. The determination of binding is done by comparing the two spectra and is thus typically a “differential” measurement. Alternatively, two or more measurements may be made as a function of time after exposure of the particles to the analyte (i.e., a kinetic measurement) and the difference between any two spectra obtained in the series may be used to detect analyte binding.

Specifically, to detect binding of an analyte to a capture probe, at least one capture probe is applied to the spheroidized microspheres of the invention. The microspheres are optionally scanned, (i.e., irradiated with light of varying wavelength, over an analytical wavelength range within an optical wavelength range) one or more times over the analytical wavelength range to produce at least one first reference resonant scattering spectrum for each particle. The microspheres are scanned using a light scanning source such as a scanning diode laser or tunable dye laser. In principle, any optical wavelength range is applicable for the measurements of this invention. Preferably, the optical wavelength range is from about 275 to about 1900 nanometers, more preferably from about 600 to about 1650 nanometers. Preferably, the analytical wavelength range has a span of about 1 nanometers to about 20 nanometers, more preferably about 10 nanometers in width. More preferably the analytical wavelength range has a span of 10 nanometers from about 770 to about 780 nanometers.

The bioactive microspheres are then contacted with a sample suspected of containing an analyte. The bioactive microspheres are then scanned over the analytical wavelength range using the light scanning source one or more times to produce at least one second binding resonant light scattering spectrum for each particle. Detection of analyte binding is done by comparing either any one of the second binding resonant light scattering spectra to any one of the first reference resonant light scattering spectra, preferably the one most recently obtained, or any one of the second binding resonant light scattering spectra with a previous second binding resonant light scattering spectrum in the series. The amount of analyte in the sample may be determined by comparing the differences between the two compared resonant light scattering spectra, specifically, the degree of shift of the scattering pattern observed upon binding. The amount of analyte in the sample may then be determined from a calibration curve prepared using known standards, as is well known in the art.

The bioactive microspheres of the invention may also be used for particle identification, a combination of particle identification and detection of binding, identification of analytes, and detection of analyte dissociation, as described by Prober et al., supra.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “h” means hour(s), “s” means second(s), “μL” means microliter(s), “mL” means milliliter(s), “L” means liter(s), “nm” means nanometer(s), “mm” means millimeter(s), “cm” means centimeter(s), “μm” means micrometer(s), “mM” means millimolar, “M” means molar, “mmol” means millimole(s), “pmole” means micromole(s), “g” means gram(s), “g” means microgram(s), “mg” means milligram(s), “ev” means electron volts, “A” means ampere(s), “rpm” means revolutions per minute, and “ESCA” means electron spectroscopy for chemical analysis, also known as X-ray photoelectron spectroscopy.

### Example 1

### Spheroidization of Barium Titanate Glass Microbeads

The purpose of this Example was to spheroidize glass microbeads having the composition:
[Ba₁₋ₓTi_{y}Si_{y′}B_{y″}Ca_{y′″}O_{(1-x+2y+2y′+3/2y″+y′″)}]₁₋ₐ(AO_{z})ₐ;
wherein x=y+y′+y″+y′″; y=0.394; y′=0.113; y″=0.134; y′″=0.066; a=0.005; 2≧z≧0.5; and wherein A is a combination of Fe, Sr, Na, and Zr, and to demonstrate their improved resonant light scattering properties. The surface composition of the spheroidized glass microspheres was analyzed using ESCA.
Spheroidization of Glass Microbeads:

Glass microbeads having the aforementioned composition were obtained from MO-SCI Specialty Products, LLC. (a subsidiary of MO-SCI Corporation, Rolla, Mo.). The microbeads had a size range of 10 to 40 μm. Ten grams of the microbeads were spheroidized using the thermal plasma reactor shown in FIG. 1 and described above, using argon as the plasma gas with a flow rate of 14 L/min. The reactor was operated with a current between 135 to 175 A, which generated a plasma temperature of about 9,000° C., and oxygen was admitted into the reactor at a flow rate of 14 L/min. The glass microbeads were fed into the reactor through the powder feed port at a rate of approximately 1 g/min with oxygen flow. Then, the microbeads entered a quench chamber where they diverged and were cooled by oxygen at a flow rate of 30 L/min, which was fed through the three radial ports in the quench chamber. The microbeads entered an adapter and passed into the product collector, which consisted of a 3 μm sintered Inconel® filter, obtained from GKN Sinter Metals (Chicago, Ill.). The spheroidization process was repeated one more time by feeding the product from the first pass through the reactor.

ESCA Analysis of Spheroidized Microspheres:

ESCA analysis was done using a PHI Model Quantera®SXM instrument (Physical Electronics USA, Chanhassen, Minn.). Monochromatized aluminum K-alpha X-rays were focussed on the glass beads, which were pressed into Indium foil, and the kinetic energies of photo-excited core electrons were analyzed by a hemispherical energy analyzer, with pass energy set to 55 eV. Charge compensation in the form of a dual electron and argon ion beam system was used. Data was collected from a 1500×200 μm² area encompassing multiple beads, or from a 15 μm diameter circle for single-bead analysis. Analysis areas were chosen to minimize signal from the Indium. The exit angle of the photoelectrons detected was 45 degrees. Quantification was based on peak areas calculated after Shirley background subtraction, by multiplication with calculated atomic sensitivity factors corrected for the analyzer transmission function. Atom % concentrations were normalized to 100%.

The results of the analysis are given in Table 1 as the atom ratio of silicon at the surface relative to the sum of the major elements present in the glass composition as defined by the formula (these elements do not include the elements designated by “A”). As can be seen from the data in the table, the silicon content at the surface of the microbeads increased after multiple spheroidizations.

TABLE 1
Results of ESCA Analysis of Barium Titanate Microspheres

| | Atom Ratio or Mole Fraction: |
|---|---|
| Treatment | Si/(Ba + Ti + Si + B + Ca) |
| Before spheroidization | 0.200 |
| After two spheroidizations | 0.308 |

The surface enrichment of silicon was calculated using the following formula:
% surface enrichment=[((atom ratio of Si after spheroidization)−(atom ratio of Si before spheroidization))/(atom ratio of Si before spheroidization)]×100
The surface enrichment of silicon was about 50%.
Resonant Light Scattering Analysis:

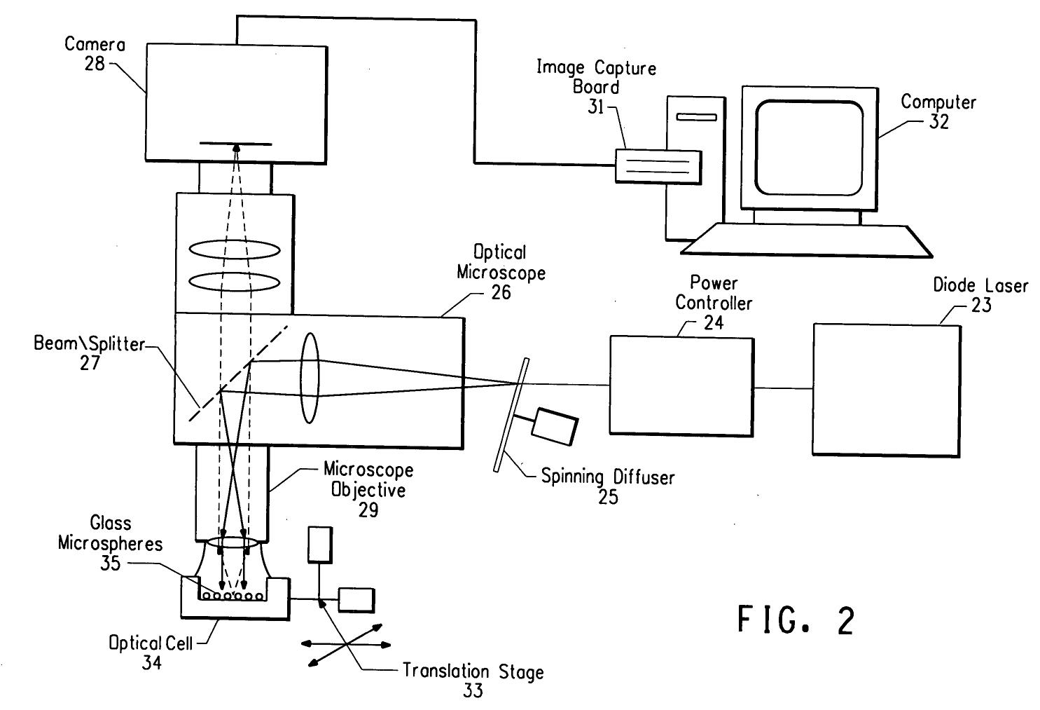

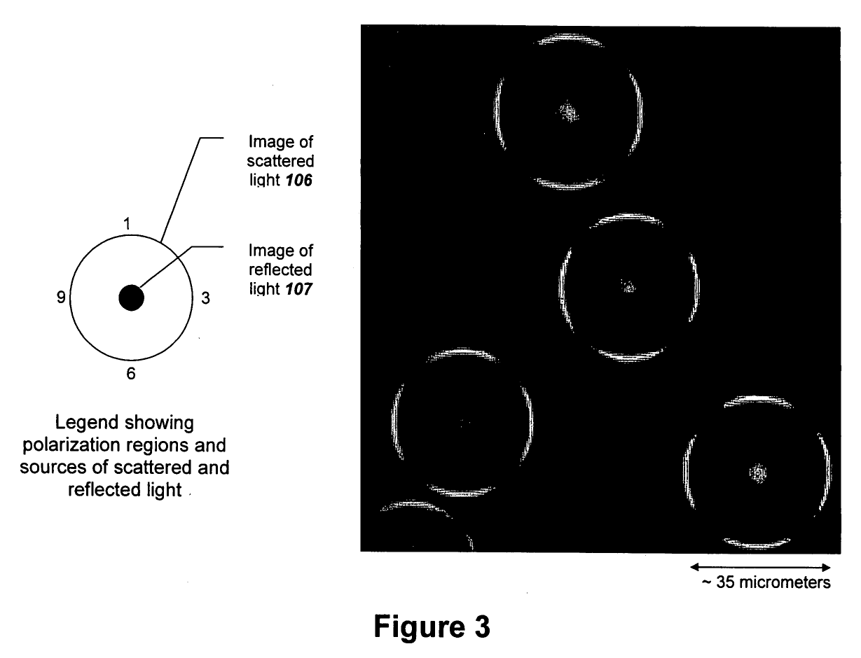

The resonant light scattering properties of the spheroidized microspheres were analyzed using the method and instrumentation (shown in FIG. 2) described below. The spheroidized microspheres were sized by screening on minus 40 μm and plus 35 μm screens for the resonant light scattering analysis. Approximately 50 mg of the spheroidized microspheres was placed in approximately 1 mL of distilled water and a suspension was created by gentle agitation of the sample container. A sample of approximately 0.1 mL of the suspension containing the glass microspheres (035) was placed in an open top optical cell (034), shown in FIG. 2, which contained a micro-machined silicon substrate containing inverted pyramidal pits to stabilize the position of the microspheres. The cell was placed on a translation stage (033) in the detection apparatus, as shown in FIG. 2. The microscope (026) (Model U-KMAS, Olympus Industrial) was set up for bright field illumination using a diode laser (023) (Model Velocity 6312, New Focus, Inc.), operating at constant current, as the light source. The output of the laser passed through an electro-optic power controller (024) (Model MI-10450-NIR, Brockton Electro-Optics) which was used to flatten the gain structure of the laser output and control the power of the laser radiation delivered to the microscope. Upon exiting the power controller the laser beam passed through a holographic diffuser (025) (Model LSD5GL3-2.75/0.25, Physical Optics) spinning at 1800 rpm. This spinning diffuser served to eliminate the laser speckle pattern in the illumination field, which would otherwise interfere with the acquisition and analysis of image data. The standard beam splitter installed by the microscope manufacturer was replaced by a pellicle-type beam splitter (027) (National Photocolor) in order to eliminate interference fringes in the image. To acquire scattering spectra from a multiplicity of particles simultaneously, a set of particles was first placed in the field of view of the microscope and focused with the objective lens (029) (Model UMPLFL 20XW, Olympus Industrial). Once the particles of interest were in the field of view and focused, the laser was scanned in wavelength, typically from 780 to 770 nm in 20 s. During this scan, the digital camera (028) (Model KP-F120CL-S5-R2, Hitachi Instruments) acquired a complete scattered light image of the field of view at each wavelength. Each image was captured by an image capture board (031) (PCI-1428, National Instruments) installed in a personal computer (032) (Dell Precision 370 Workstation). Custom software was written to store each image (Heineman, U.S. Patent Application Publication No. 2006/0066851). A wavelength scan resulted in a set of linked images, one for each wavelength in the scan. A typical image is shown in FIG. 3. To determine the scattering spectrum of each particle in the field of view from a set of wavelength-linked images, software was written to identify a representative region or regions of the image corresponding to each particle, for example a portion of the ring-shaped scattered light image (106) surrounding the bright spot of reflected light (107) at each particle center, as seen in the image of FIG. 3. In this Example, the incident and scattered light beams were polarized independently, with the two axes of polarization parallel to each other. This resulted in sectors of scattered light centered approximately at the 12:00, 3:00, 6:00, and 9:00 positions of the circle as indicated for the center image of FIG. 3 by the numbers 12, 3, 6, and 9 respectively. Theory predicts, and results confirm, that scattered light spectra from the “12” and “6” regions are equivalent and scattered light spectra from the “3” and “9” regions are equivalent. Furthermore, spectra from the two pairs of sectors are different from one another.

The spectral quality of a population of microspheres was determined by sampling at least 30 microspheres and examining the resonant light scattering spectrum of each microsphere from the four scattered light sectors. In this analysis, pixels containing spectral information in each sector were analyzed in a 30 degree cone. One resonant scattering spectrum was derived from each of the four regions (at 12, 3, 6 and 9 on FIG. 3) by selecting the outer two pixels in a 30 degree angle for each one of the four regions. Each spectrum represented the spectra averaged over the pixels in the 30 degree angle of the outer two pixels for each one of the four regions.

A high quality spectrum had at least three identifiable resonances representing individual peak assignments in at least one of the four regions (12, 3, 6 or 9 in FIG. 3). The resonances which were observed are solutions of equations that are typically expressed in terms of Ricati-Bessel functions (see G. Roll and G. Schweiger, “Geometric Optics Model of Mie Resonances”, J. Opt. Soc. Am. A, 17(7) 1301 (2000)) and can typically be assigned a mode and order. The cluster of resonances also can repeat at difference wavelengths, and this is a direct consequence of the optical radius of the microbead. Examples of a high quality resonant light scattering spectrum and two unacceptable resonant light scattering spectra from single microspheres are shown in FIGS. 4a and 4b and 4c, respectively. It should be noted that in a population of the commercial microbeads, there are some microbeads that have high quality resonant light scattering properties and some that have unacceptable resonant light scattering properties. The percent of high quality microbeads and the percent improvement in the number of microbeads having a high quality resonant light scattering spectrum after the spheroidization process is given in Table 2. The percentage improvement that is tabulated is calculated by the following formula:
Percent Improvement=100((a−b)/b)

wherein a is the number of high quality spheroidized microspheres divided by the total number of microspheres in the spheroidized sample, and b is the number of high quality microspheres in the non-spheroidized, control sample divided by the total number of microspheres in the non-spheroidized, control sample.

TABLE 2
Results of Resonant Light Scattering Measurements of a
Population of Microspheres After Spheroidization Cycles

| Spheroidization | Percent of High Quality | Percentage |
|---|---|---|
| Cycle | Microbeads | Improvement |
| Untreated | 31 ± 3% | Control |
| Cycle 1 | 58% | 87% |
| Cycle 2 | 62% | >90% |

As can be seen from the data in Table 2, there was a significant increase in the percentage of microspheres having a high quality resonant light scattering spectrum after two spheroidizations.

What is claimed is:

1. A population of bioactive glass microspheres having enhanced resonant light scattering properties produced by a process comprising the steps of:
a) subjecting a batch of glass forming ingredients to a spheroidization process two or more times wherein the spheroidization process comprises the steps of:
i) providing a batch of glass forming ingredients;
ii) heating the glass forming ingredients of (i) with a heat source that provides a temperature of about 2,000° C. to about 12,000° C. wherein the glass forming ingredients are in motion during the heating;
iii) quenching the heated ingredients of (ii) wherein a population of microspheres having enhanced resonant light scattering properties is formed; and
b) applying at least one capture probe to the surface of the population of microspheres of (a)(iii) wherein the capture probe is bioactive.

2. A population of bioactive glass microspheres according to claim 1 wherein the glass forming ingredients are comprised of materials that are oxides or oxide precursors of elements selected from the group consisting of: barium, titanium, iron, sodium, calcium, boron, niobium, tantalum, lanthanum, silicon, strontium, chromium, and tungsten.

3. A population of bioactive glass microspheres according to claim 2 wherein the glass forming ingredients have a composition of:
[Ba₁₋ₓTi_{y}Si_{y′}B_{y″}Ca_{y′″}O_{(1-x+2y+2y′+3/2y″+y′″)}]₁₋ₐ(AO_{z})ₐ,
wherein 0.6>y>0.1; 0.6>y′>0.05; 0.6>y″≧0; 0.4>y′″>0; x=y+y′+y″+y′″; A is any of, or a combination of Na, Fe, Sr, and Zr; 0.01>a≧0, and 2≧z≧0.5.

4. A population of bioactive glass microspheres according to claim 3 wherein the glass forming ingredients have a composition of:
[Ba₁₋ₓTi_{y}Si_{y′}B_{y″}Ca_{y′″}O_{(1-x+2y+2y′+3/2y″+y′″)}]₁₋ₐ(AO_{z})ₐ;
wherein x=y+y′+y″+y′″; y=0.394; y′=0.113; y″=0.134; y′″=0.066; a=0.005; 2≧z≧0.5; and wherein A is a combination of Fe, Sr, Na, and Zr.

5. A population of bioactive glass microspheres according to claim 2 wherein the glass forming ingredients have a composition of:
[Ba₁₋ₓLa_{y}Si_{y′}Ti_{y″}B_{y′″}Ca_{y′″″}O_{(1-x+3/2 y+2y′+2 y″+3/2 y′″+2 y″″)}]₁₋ₐ(AO_{z})ₐ;
wherein 0.5>y>0.1; 0.6>y′>0.05; 0.6>y″>0.04; 0.4>y′″≧0; 0.3>y″″≧0; x=y+y′+y″+y′″+y″″; where A is any of, or a combination of Cr, Fe, W, Na and Zr; 0.01>a≧0; and 3≧z≧0.5.

6. A population of bioactive glass microspheres according to claim 5 wherein the glass forming ingredients have a composition of:
[Ba₁₋ₓLa_{y}Si_{y′}Ti_{y″}B_{y′″}Ca_{y′″″}O_{(1-x+3/2 y+2y′+2 y″+3/2 y′″+2 y″″)}]₁₋ₐ(AO_{z})ₐ;
wherein y=0.171, y′=0.401, y″=0.044, y′″=0.0614, y″″=0.0194, x=y+y′+y″+y′″+y″″; a=0.0044; 3≧z≧0.5; and A is a combination of Cr, Fe, W, Na, and Zr.

7. A population of bioactive glass microspheres according to claim 1 wherein the heat source is a plasma torch.

8. A population of bioactive glass microspheres according to claim 7 wherein the plasma torch is an argon plasma torch.

9. A population of bioactive glass microspheres according to claim 1 wherein the glass forming ingredients are in a form selected from the group consisting of glass powders, glass beads, crushed glass particles, glass flakes, and raw glass batch.

10. A population of bioactive glass microspheres according to claim 1 wherein said microspheres have a refractive index of about 1.6 to about 2.1.

11. A population of bioactive glass microspheres according to claim 1 wherein said microspheres have a silicon surface enrichment of 3% or greater as determined by X-Ray Photoelectron Spectroscopy analysis.

12. A population of bioactive glass microspheres according to claim 1 wherein the capture probe is one member of a binding pair.

13. A population of bioactive glass microspheres according to claim 12 wherein the one member of a binding pair is selected from the binding pair combinations consisting of: antigen/antibody, antigen/antibody fragment, Protein A/antibody, Protein G/antibody, hapten/anti-hapten, biotin/avidin, biotin/streptavidin, folic acid/folate binding protein; hormone/hormone receptor, lectin/carbohydrate, enzyme/cofactor, enzyme/substrate, enzyme/inhibitor, peptide nucleic acid/complimentary nucleic acid, polynucleotide/polynucleotide binding protein, vitamin B12/intrinsic factor; complementary nucleic acid segments; pairs comprising sulfhydryl reactive groups, pairs comprising carbodiimide reactive groups, and pairs comprising amine reactive groups.

14. A population of bioactive glass microspheres according to claim 1 wherein at least about 60% of microspheres in said population of bioactive glass microspheres produce a high quality resonant light scattering spectrum.

15. A population of bioactive glass microspheres according to claim 1 wherein at least about 70% of microspheres in said population of bioactive glass microspheres produce a high quality resonant light scattering spectrum.

16. A population of bioactive glass microspheres having enhanced resonant light scattering properties produced by a process comprising the steps of:
a) subjecting a batch of glass beads to a spheroidization process two or more times wherein the spheroidization process comprises the steps of:
i) providing a batch of glass beads having a composition selected from the group consisting of:
[Ba₁₋ₓLa_{y}Si_{y′}Ti_{y″}B_{y′″}Ca_{y′″″}O_{(1-x+3/2 y+2y′+2 y″+3/2 y′″+2 y″″)}]₁₋ₐ(AO_{z})ₐ; A)
wherein 0.6>y>0.1; 0.6>y′>0.05; 0.6>y″y>0; 0.4>y′″≧0; x=y+y′+y″+y′″; A is any of, or a combination of Na, Fe, Sr, and Zr; 0.01>a≧0, and 2≧z≧0.5; and
[Ba₁₋ₓLa_{y}Si_{y′}Ti_{y″}B_{y′″}Ca_{y′″″}O_{(1-x+3/2 y+2y′+2 y″+3/2 y′″+2 y″″)}]₁₋ₐ(AO_{z})ₐ; B)
wherein 0.5>y>0.1; 0.6>y′>0.05; 0.6>y″>0.04; 0.4>y′″y≧0; 0.3>y″″≧0; x=y+y′+y″+y′″+y″″; where A is any of, or a combination of Cr, Fe, W, Na and Zr; 0.01>a≧0; and 3≧z≧0.5;
ii) heating the glass beads of (i) in an argon plasma reactor that provides a temperature of about 6,000° C. to about 9,000° C. wherein the glass beads are passed through the reactor at a flow rate of about 0.5 grams per minute to about 10 grams per minute;
iii) quenching the heated glass beads of (ii) by passing a gas over the heated glass beads wherein a population of microspheres having enhanced resonant light scattering properties is formed; and
b) applying at least one capture probe to the surface of the population of microspheres of (a)(iii) wherein the capture probe is bioactive.

17. A population of bioactive glass microspheres according to claim 16 wherein the glass beads are passed through the reactor in step (a)(ii) at a flow rate of about 1 gram per minute.

18. A population of bioactive glass microspheres according to claim 16 wherein the gas used to quench the heated glass beads in step (a)(iii) is oxygen.

19. A population of glass microspheres having enhanced resonant light scattering properties wherein said microspheres comprise the following characteristics:
a) a silicon surface enrichment of about 3% or greater as determined by X-Ray Photoelectron Spectroscopy analysis;
b) a composition selected from the group consisting of:
[Ba₁₋ₓTi_{y}Si_{y′}B_{y″}Ca_{y′″}O_{(1-x+2y+2y′+3/2y″+y″″)}]₁₋ₐ(AO_{z})ₐ, (i)
wherein 0.6>y>0.1; 0.6>y′>0.05; 0.6>y″≧0; 0.4>y′″≧0; x=y+y′+y″+y′″; A is any of, or a combination of Na, Fe, Sr, and Zr; 0.01>a≧0, and 2≧z≧0.5; and
[Ba₁₋ₓLa_{y}Si_{y′}Ti_{y″}B_{y′″}Ca_{y′″″}O_{(1-x+3/2 y+2y′+2 y″+3/2 y′″+2 y″″)}]₁₋ₐ(AO_{z})ₐ; (ii)
wherein 0.5>y>0.1; 0.6>y′>0.05; 0.6>y″>0.04; 0.4>y′″≧0; 0.3>y″″≧0; x=y+y′+y″+y′″+y″″; where A is any of, or a combination of Cr, Fe, W, Na and Zr; 0.01>a≧0%; and 3≧z≧0.5; and
c) a refractive index of about 1.6 to about 2.1.

20. A population of glass microspheres according to claim 19 optionally comprising at least one bioactive capture probe.

21. A method for the detection of analyte binding to a bioactive glass microsphere comprising:
a) providing a light scanning source which produces light over an analytical wavelength range;
b) providing at least one bioactive glass microsphere from the population of bioactive glass microspheres according to any of claims 1, 16, or 20 having a capture probe, wherein the capture probe has affinity for at least one analyte;
c) optionally scanning the bioactive glass microsphere of (b) one or more times over the analytical wavelength range to produce at least one first reference resonant light scattering spectrum for the bioactive glass microsphere of (b);
d) contacting the bioactive glass microsphere of (c) with a sample suspected of containing at least one analyte where, if the analyte is present, binding occurs between the at least one capture probe and the at least one analyte;
e) scanning the bioactive glass microsphere of (d) one or more times over the analytical wavelength range to produce at least one second binding resonant light scattering spectrum for each bioactive glass microsphere of (d); and
f) detecting binding of the at least one analyte to the at least one capture probe by comparing the differences between the resonant light scattering spectra selected from the group consisting of: any of the at least one first reference light scattering spectrum and any of the at least one second light scattering spectrum.
